(19) United States
(12) Patent Application Publication
(10) Pub. No.: US 2013/0318833 A1
(43) Pub. Date: Dec. 5, 2013

(54) METHOD AND MOULD FOR PRODUCING FOOTWEAR AND FOOTWEAR THUS OBTAINED

(71) Applicants: José Maria Izquieta Anaut, Pamplona (ES); Ramób Baltasar Pajares Salinas, Callosa de Segura (ES); Francisco Manuel Urban Bru, Elche (ES)

(72) Inventors: José Maria Izquieta Anaut, Pamplona (ES); Ramób Baltasar Pajares Salinas, Callosa de Segura (ES); Francisco Manuel Urban Bru, Elche (ES)

(73) Assignees: DESARROLLO INTEGRAL DEL MOLDE, S.L., Pamplona, Navarra (ES); PLASTINHER, S.L., Elche, Alicante (ES); INDUSTRIAL ZAPATERA, S.A., Callose de Segura, Alicante (ES)

(21) Appl. No.: 13/638,909

(22) PCT Filed: Mar. 2, 2010
(86) PCT No.: PCT/ES10/70111

§ 371 Date: Oct. 1, 2012

(51) Int. Cl. B29D 35/00

(52) U.S. Cl. CPC B29D 35/0018; B29D 35/0009
USPC 36/3 B; 264/244; 425/119

(57) ABSTRACT

The present invention consists in an injection method in which a material is injected which serves as the connection between the upper and the sole of the shoe, the mould used for this purpose and the shoe thus obtained in such a manner that the membranes of the breathable type incorporated in said shoe are not damaged.

### OBJECT OF THE INVENTION

The present invention lies within the field of the methods of manufacturing shoes in which a material is injected to obtain the finished shoe, the mould used and the shoe thus obtained.

Said invention is a method of injection in which a material is injected which serves as the connection between the upper and the sole of the shoe, the mould used for this purpose and the shoe thus obtained in such a manner that the breathable membranes incorporated in said shoe are not damaged.

### ANTECEDENTS OF THE INVENTION

Methods, moulds and shoes obtained by means of injecting a material, which serves as a connection between the upper and the sole of the shoe are of prior art.

Said methods, moulds and shoes inject the material onto the sealed upper and sole, i.e. the material is injected onto a fully closed cavity bounded by parts of the aforementioned mould, upper and sole.

Current trends make it necessary for the shoe to include elements, which improve comfort, such as breathable elements. This necessitates perforating the soles and other elements of the shoe, or at least ensuring that they exhibit a greater or lesser degree of porosity.

Therefore the methods, moulds and shoes obtained by means of the inventions of prior art suffer from the disadvantage that they do not include the breathable elements which the current trends in the market require, since said elements, due to their porosity and therefore their non-tight nature, allow the passage of the injected material through them, which means that their orifices or pores are closed and their breathability is unused.

### DESCRIPTION OF THE INVENTION

In the light of the above, the present invention relates to a method for manufacturing shoes which comprises the following steps:
placing the sole on the mould plunger, which in turn comprises a breathable, impermeable membrane which is visible through windows in the sole,
placing the means of breathing and damping in the upper part of the sole and in the space bounded by a lip,
placing the upper between the rings of the mould
closing the rings of the mould in order to fix the upper,
moving the plunger towards the rings so that the breathing and damping means are pressed against the external lower face of the upper,
injecting material in the space between the upper, the breathing and damping means, the sole and the rings,
opening the rings of the mould to release the upper,
removing the shoe thus formed.
   The present invention also relates to a mould for manufacturing shoes which comprises:
rings for fixing the upper, which are the two halves of a ring split into the areas of the tip and heel of the shoe,
plunger with the tread of the sole it is to receive, with a relative movement of translation along the inner surface of the rings.

This invention also relates to a shoe formed by the method described, which comprises:
an upper, which in turn comprises a breathable, impermeable membrane which is visible through windows in the sole,
breathing and damping means located between the outer lower face of the upper and the inner face of the sole, and in the space bounded by the lip of the sole,
injected material serving as the connection between the upper, the sole and the breathing and damping means.
   The options and variants are covered by the corresponding dependent claims.

### BRIEF DESCRIPTION OF THE FIGURES

This specification is supplemented by a set of figures illustrating the preferred embodiment, which is by no means exhaustive, of the invention.

FIG. 1A shows a transverse section of the mould and the shoe before the mould is closed.

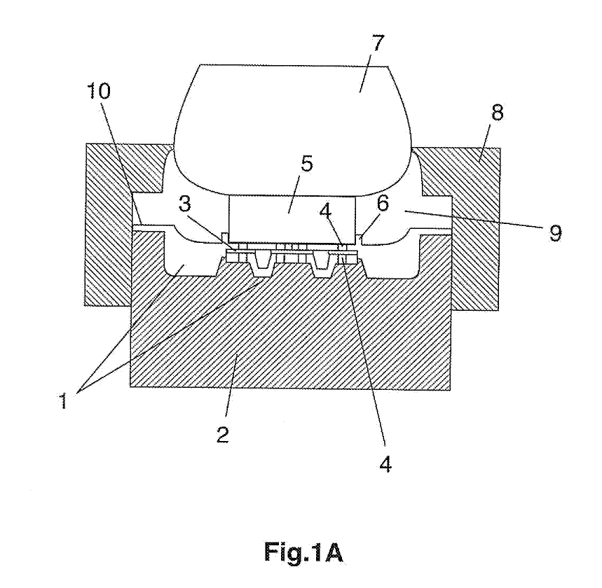

FIG. 1B shows a transverse section of the mould and the shoe with the mould closed.

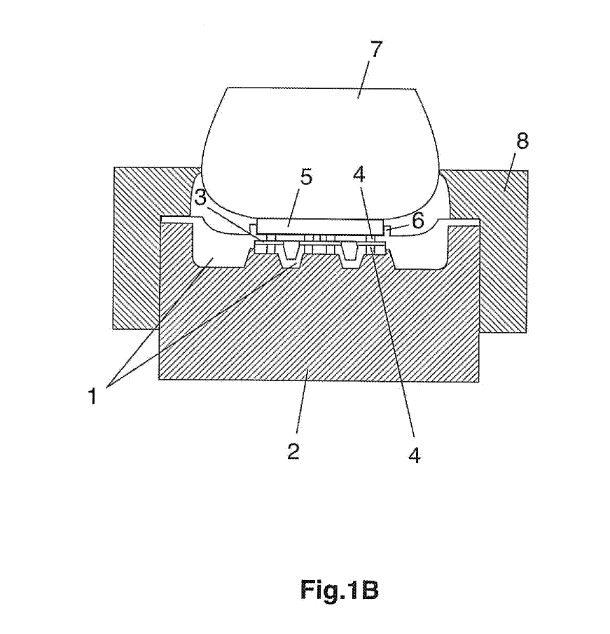

### DETAILED DESCRIPTION OF THE INVENTION

The invention is described in detail below, so that when “lower” and “upper” are mentioned, this refers to locations where the shoe is placed in its position of use, i.e. the sole (1) supported on the ground; when “inner” and “outer” are mentioned, this is equally from the perspective of the user of the shoe, i.e. “inner” is towards the inside of the shoe and is therefore concealed from the user, and “outer” is towards the outside or outside the shoe.

The method for manufacturing shoes according to a preferred embodiment comprises the following steps:
placing the sole (1) on the plunger (2) of the mould,
placing the breathing and damping means (5) in the upper part of the sole (1) and in the space bounded by a lip (6),
placing the upper (7) between the rings (8) of the mould,
closing of the rings (8) of the mould for fixing the upper (7),
moving the plunger (2) towards the rings (8) so that the breathing and damping means (5) are pressed against the outer lower face of the upper (7),
injection of material in the space (9) between the upper (7), the breathing and breathing means (5), the sole (1) and the rings (8),
opening of the rings (8) of the mould to release the upper (7),
removal of the shoe thus formed.

In an embodiment of the invention the breathing and breathing means (5), before the mould is closed, have the thickness sufficient for its upper surface to make contact with the upper (7). Thus when the plunger (2) moves to close the mould, said breathing and damping means (5) are pressed against the upper (7), creating a barrier against the injected plastic.

In another embodiment not shown the breathing and damping means (5) would not have the aforementioned thickness, i.e. before the mould is closed they would come into contact with the upper (7) because at the upper level of material injected during closing of the mould it would never project from the upper surface of the breathing and damping means (5), and the injected plastic would never project above them.

The aforementioned elements, corresponding to parts of the mould, are those of prior art, more specifically in methods known as injection to the upper (7).

Therefore the plunger (2) is a moving part of the mould in which the sole (1) is placed.

The rings (8) of the mould which secure the upper (7) of the shoe are named as such and are known in this form in the state of the art, although strictly speaking they are two half-rings (8) which are formed by splitting a ring which runs around the entire periphery of the upper (7). Normally, and in this preferred embodiment, the splitting is effected in the region of the tip and in the region of the heel of the shoe.

The aforementioned sole (1) comprises in turn a breathable, permeable membrane (3) which is visible through windows (4) in the sole (1), as shown in the Spanish patent of one of the applicants under application number 200600272.

The breathing and damping means (5) may consist of a block of breathable, compressible, spongy material, or may consist of a compressible material with orifices not shown in the figures, which favour breathing.

In the latter case said orifices of the breathing and damping means (5) coincide with the orifices of the sole (1), thereby creating a direct channel from the inside of the sole (1) to the outside of the shoe to allow discharge of sweat via said channel.

The damping characteristic of these means implies that the same have a recuperation memory to ensure that said characteristic is repeated for each footprint.

Both the breathable and impermeable membrane (3) and the breathing and damping means (5) may be placed on a shoe in one more regions, for example, some in the heel and others in the central region, and they may also be duplicated, tripled etc. in the same shoe, for example there may be two in the front section of the shoe, another around the tip and then another toward the central section of the shoe.

During walking the compression of the breathing and damping means (5) act as an impeller pump for perspiration, which as has just been mentioned, will pass directly to the outside of the shoe for its expulsion.

Thanks to the characteristics of the components of the shoe, specifically the membrane (3) and breathing and damping means (5), the perspiration can pass from the inside to the outside of the shoe, but conversely the water cannot enter from the outside to the inside of the shoe, which would invalidate the comfort of the user due to perspiration.

The sole (1) has a lip (6) or partition wall on its upper surface so that this lip (6) performs the following functions:
on the one hand it serves as a barrier against the injected plastic to protect the breathing and damping means (5) of the shoe and the pressure of said plastic;
on the other hand it serves as a positioner of said breathing and damping means (5) on the sole (1) at the time placing both, the sole (1) and means(5), inside the mould;
and finally it serves as a fixer of the position of said breathing and damping means (5), thus preventing the pressure of the injected plastic from moving them.

Said sole is also provided with an optional tab (10) on its outermost peripheral edge which favours the closing of the sole (1) with the mould and which is cut once the shoe is formed, i.e. it terminates the injection of the material.

By means of the method mentioned, and using the mould also mentioned here, a shoe is obtained which includes a sole (1), with a breathable and impermeable membrane (3), the upper (7), breathing and damping means (5) and a material connecting all the aforementioned elements.

It should be emphasised that the shoe thus obtained is fully completed and no subsequent operation is required to obtain a fully finished shoe ready for use.

Similarly, the invention described is applicable to all styles or classes of shoes: safety, casual or dress, girl's or boy's shoes, mountaineering, orthopaedic, sports, anatomical, ski or pre-ski shoes, etc.

1. A method for manufacturing a shoe which comprises the following steps:
placing the sole (1) on the mould plunger (2), which in turn comprises a breathable, impermeable membrane (3) which is visible through windows (4) in the sole (1),
placing the means of breathing and damping (5) in the upper part of the sole (1) and in the space bounded by a lip (6),
placing the upper (7) between the rings (9) of the mould
closing the rings (8) of the mould in order to fix the upper (7),
moving the plunger (2) towards the rings (8) so that the breathing and damping means (5) are pressed against the external lower face of the upper (7),
injecting material in the space (9) between the upper (7), the breathing and damping means (5), the sole (1) and the rings (8),
opening the rings (8) of the mould to release the upper (7),
removing the shoe thus formed.

2. The method for manufacturing a shoe according to claim 1, characterised in that the material is injected before the plunger (2) is moved towards the rings (8).

3. The method for manufacturing a shoe according to claim 1, characterised in that after the shoe is removed the extra tab (10) of the sole (1) is cut.

4. The method for manufacturing a shoe according to claim 1, characterised in that the material injected is polyurethane or injectable thermoplastic, polyvinyl chloride or rubber.

5. A mould for manufacturing a shoe according to claim 1, which comprises:
rings (8) for fixing the upper (7), which are the two halves of a ring split in the regions of the tip and heel of the shoe,
plunger (2) with the tread of the sole (1), which it will receive, with a relative movement of translation along the inner surface of the rings (8).

6. A shoe formed according to claim 1, which comprises:
an upper (7),
a sole (1), which in turn comprises a breathable and impermeable membrane (3) which is visible through windows (4) in the sole (1),
breathing and damping means (5) located between the outer lower face of the upper (7) and the inner face of the sole (1) and in the space bounded by the lip (6) of the sole (1),
injected material serving as the connection between the upper (7), the sole (1) and the breathing and damping means (5).

7. The shoe according to claim 6, characterised in that the breathing and damping means (5) are of a foam type porous material.

8. The shoe according to claim 6, characterised in that the breathing and damping means (5) have orifices, which coincide with the orifices of the sole (1) on which they are supported.
